(19) United States
(12) Patent Application Publication
(10) Pub. No.: US 2012/0014617 A1
(43) Pub. Date: Jan. 19, 2012

(54) SYSTEM AND METHOD FOR MULTI-SCALE IMAGE RECONSTRUCTION USING WAVELETS

(76) Inventor: BRUCE H. DEAN, New Market, MD (US)

(21) Appl. No.: 12/839,187

(22) Filed: Jul. 19, 2010

(51) Int. Cl. G06K 9/40

(52) U.S. Cl. 382/260

(57) ABSTRACT

Disclosed herein are systems, methods, and non-transitory computer-readable storage media for reconstructing an image. A system practicing the method receives a corrupted image, such as a blurred image or a still frame from a video, to reconstruct, isolates a set of spatial frequencies in the corrupted image using a wavelet transform, generates restored spatial frequency information for the set of spatial frequencies, and generates a reconstructed image based on the restored spatial frequency information and the corrupted image. Generating the reconstructed image can occur in parallel or in a specific order. The set of spatial frequencies can correspond to different zoom levels. The system can further process the corrupted image and set of spatial frequencies until convergence is reached.

### BACKGROUND

1. Technical Field

The present disclosure relates to image manipulation and more specifically to reconstructing corrupted images.

2. Introduction

Blurry, distorted, or otherwise corrupted images commonly occur in a variety of optical imaging applications. An example application producing corrupted images is with low-quality surveillance cameras. Another source of corrupted imagery is a telescope collecting data of faint, distant objects, and possibly through a turbulent atmosphere. In both cases, a user may want to enhance the corrupted image. Typically such corrupted images can only be enhanced in a very limited way, if at all. For applications such as law enforcement and astronomy, improvements in enhancing such corrupted images is of great benefit. Accordingly, what is needed in the art is an improved way to enhance or restore corrupted images.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein is a multi-scale image reconstruction technique using the wavelet transform. Multi-scale refers to the varying levels of spatial frequency information in an image. Spatial frequency information contained in a corrupted or blurred image (such as that collected by a scientific or surveillance camera) can be reconstructed simultaneously and/or sequentially at varying spatial scales using the wavelet transform. The varying spatial scales are roughly equivalent to different zoom levels with respect to the image. This approach can also provide an alternative solution for the well-known problem of image deconvolution. The overall quality of an image reconstruction or deconvolution can be improved by isolating specific spatial frequencies, and reconstructing these spatial frequencies in a specific order or in parallel. The wavelet transform provides a convenient quantitative basis set for isolating specific spatial frequencies as components of the uncorrupted image.

Disclosed are systems, methods, and non-transitory computer-readable storage media for reconstructing an image. A system practicing the method receives a corrupted image to reconstruct, isolates a set of spatial frequencies in the corrupted image using a wavelet transform, generating restored spatial frequency information for the set of spatial frequencies, and generates a reconstructed image based on the restored spatial frequency information and the corrupted image. The corrupted image can be a still frame extracted from a video. The system can process the image with the set of spatial frequencies until convergence is reached.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary computing device for processing corrupted image data;

FIG. 3 illustrates different zoom levels from a corrupted image;

FIG. 4 illustrates generating a reconstructed image based on multiple layers of spatial frequency information; and

FIG. 5 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for restoring all or part of a corrupted image. When an image is viewed at different zoom levels, the different zoom levels can provide a variety of perspectives of what is going on in the image much better than a view from a fixed position. For example, if a viewer stands back away from the image, he or she sees the broader structure of the image, whereas if the viewer is a few inches away the details of the image can be apparent. One way to quantify this as an automatic approach is to use the wavelet transform. The method samples a corrupted image with the wavelet transform to capture multiscale configurations. In one aspect, the wavelet transform is a continuous wavelet transform which can construct a time-frequency representation of a signal with time and frequency localization. The continuous wavelet transform can be represented with the following equation:

$${X}_{ω} ( a , b ) = \frac{1}{\sqrt{a}} {\int }_{- ∞}^{∞} x ( t ) {ψ}^{*} ( \frac{t - b}{a} ) d t$$

where ψ(t) is a continuous function in both the time domain and the frequency domain called a mother wavelet and * represents operation of complex conjugate.

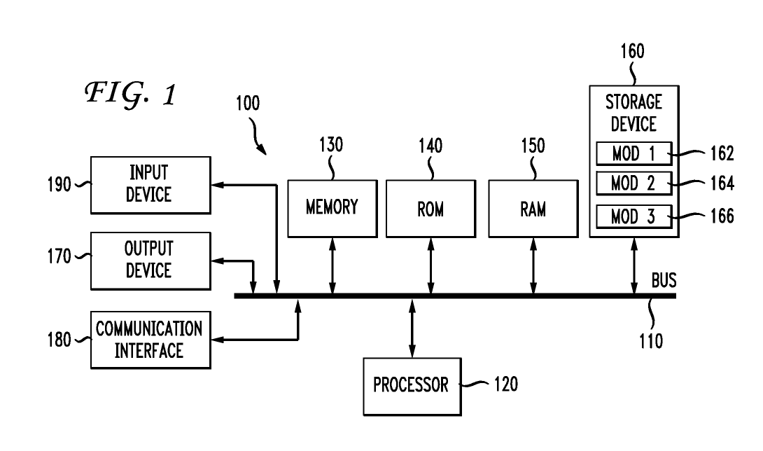

A brief introductory description of a basic general purpose system or computing device in FIG. 1 which can be employed to practice the concepts is disclosed herein. A more detailed description of how to enhance corrupted images will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

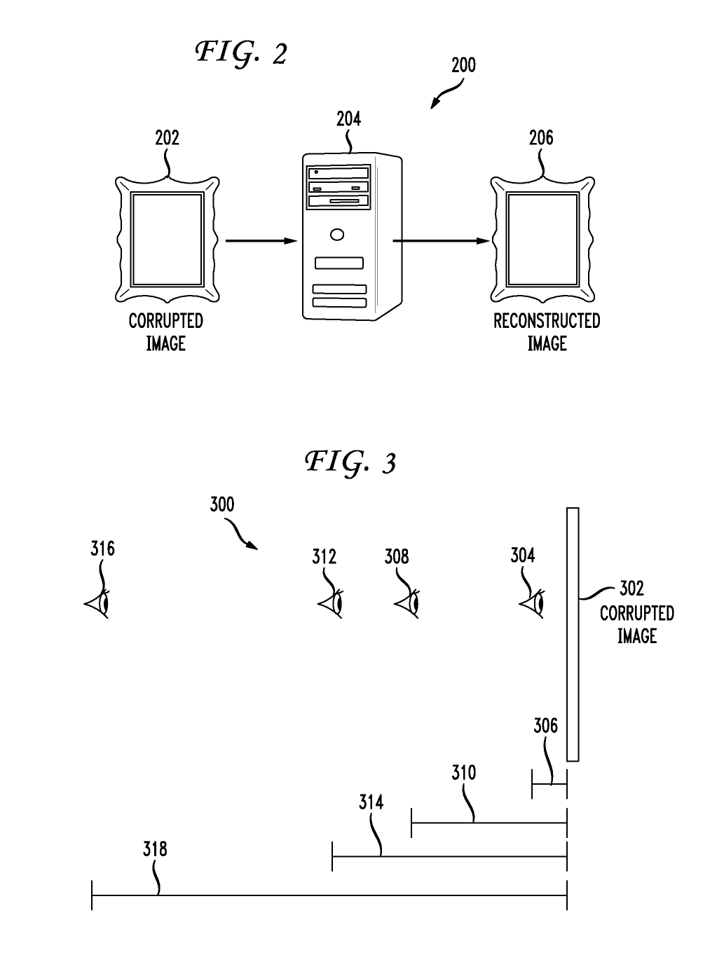

The approaches disclosed herein can provide an alternative, more effective means of reconstructing image or other data corrupted in the convolution process. Having disclosed some basic system components and concepts, an exemplary computing device 204 for processing corrupted image data 202 is shown in FIG. 2. The computing device 204 receives corrupted image data 202 for processing. The computing device 204 performs image reconstruction by first isolating specific spatial frequencies using the wavelet transform. The spatial frequencies correspond to conceptual zoom levels away from the corrupted image data. Then the computing device 204 reconstructs these spatial frequencies using standard filtering and/or deconvolution techniques. The computing device 204 can then process the data associated with specific spatial frequencies in a specific order or in parallel, and repeat or continue processing until convergence is reached.

The wavelet transform provides a convenient quantitative basis set for isolating specific spatial frequencies as components of the uncorrupted image. The original spatial frequency content in an image can be better identified by successively zooming in or out while simultaneously attempting to restore the dominant spatial frequencies of a given zoom position.

FIG. 3 illustrates different zoom levels 300 from a corrupted image. In this example, a corrupted image 302 is a digital representation of an actual image. The system examines the corrupted image from multiple distances, or at different spatial frequencies: a first viewpoint 304 at a first distance 306, a second viewpoint 308 at a second distance 310, a third viewpoint 312 at a third distance 314, and a fourth viewpoint 316 at a fourth distance 318. Each viewpoint provides a different perspective into the spatial frequencies.

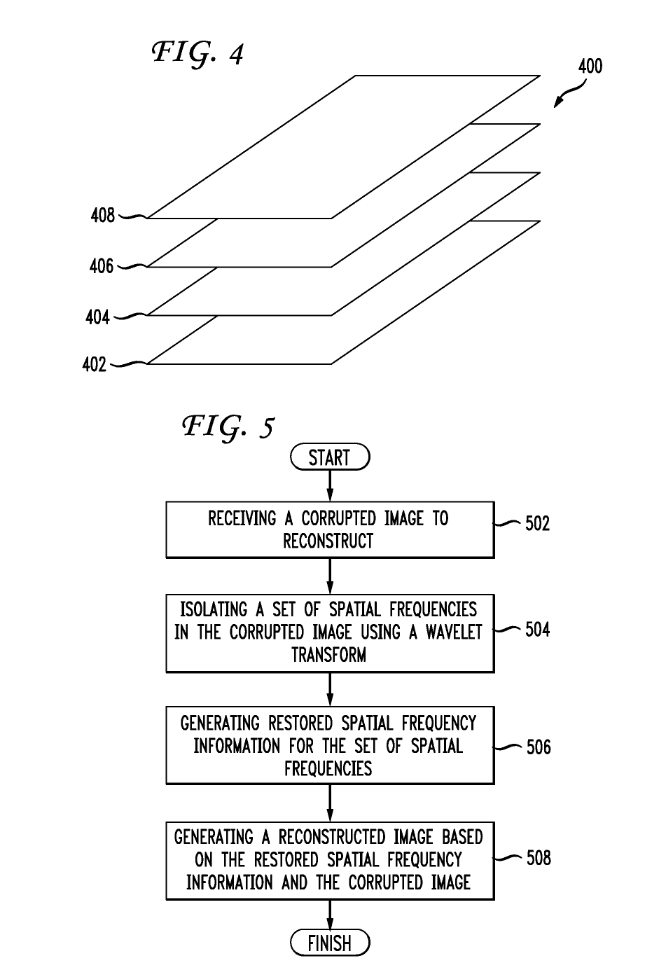

FIG. 4 illustrates generating a conceptual view 400 of a reconstructed image based on multiple layers of spatial frequency information. The computing device 204 generates an image information layer 402, 404, 406, 408 for each spatial frequency 304, 308, 312, 316. The computing device 204 can combine with and/or otherwise apply one or more of the layers to the original corrupted image. The computing device 204 can further calculate or deduce additional information from the corrupted image and the layers based on their relationships to one another.

From these different perspectives, the computing device 204 reconstructs different portions or aspects of the corrupted image based on the wavelet transform. The wavelet transform facilitates the isolation of specific spatial frequencies as basis components of the uncorrupted image. The computing device 204 produces a reconstructed image 206 based on the restored spatial frequencies, which can include dominant spatial frequencies. When this processing is complete, the computing device 204 outputs the reconstructed image 206.

Because the spatial frequencies are reconstructed individually, at intermediate steps the spatial frequencies associated with a given spatial scale provide feedback as updated starting values to the other spatial components of the image. The computing device 204 can use wavelets to approximate a continuous signal as opposed to the Fourier technique based on sin and cos functions as basis functions.

The principles disclosed herein can be applied to surveillance, lithography, map and spatial coordinate calibration, image processing, and restoring corrupted imagery. For example, a police department has images of suspects from a local merchant's video surveillance, but the surveillance footage is of poor quality and the suspects are not identifiable. A system for image reconstruction as described herein can process this kind of data to produce improved reconstructed images from which the police department can identify suspects or more clearly determine what is recorded in the surveillance footage.

Having disclosed some basic system components, the disclosure now turns to the exemplary method embodiment shown in FIG. 5. For the sake of clarity, the method is discussed in terms of an exemplary system such as is shown in FIG. 1 configured to practice the method. FIG. 5 illustrates an example method embodiment for reconstructing a corrupted image. The system 100 receives a corrupted image to reconstruct (502) and isolates a set of spatial frequencies in the corrupted image using a wavelet transform (504). The set of spatial frequencies can correspond to different zoom levels. The corrupted image can be blurred, out of focus, distorted, incomplete, and so forth. The corrupted image can be extracted from video.

The system 100 generates restored spatial frequency information for the set of spatial frequencies (506) either in parallel or in a specific order. Then the system 100 generates a reconstructed image based on the restored spatial frequency information and the corrupted image (508) and optionally processing the corrupted image with the set of spatial frequencies until convergence is reached.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied in image reconstruction in scientific, medical, security, surveillance, and military fields. Those skilled in the art will readily recognize various modifications and changes that may be made to the principles described herein without following the example embodiments and applications illustrated and described herein, and without departing from the spirit and scope of the disclosure.

We claim:

1. A method of reconstructing an image, the method comprising:
receiving a corrupted image to reconstruct;
isolating a set of spatial frequencies in the corrupted image using a wavelet transform;
generating restored spatial frequency information for the set of spatial frequencies; and
generating a reconstructed image based on the restored spatial frequency information and the corrupted image.

2. The computer-implemented method of claim 1, wherein generating the reconstructed image further comprises reconstructing the set of spatial frequencies in parallel.

3. The computer-implemented method of claim 1, wherein generating the reconstructed image further comprises reconstructing the set of spatial frequencies in a specific order.

4. The computer-implemented method of claim 1, wherein the set of spatial frequencies correspond to different zoom levels.

5. The computer-implemented method of claim 1, wherein the corrupted image is blurred.

6. The computer-implemented method of claim 1, wherein the corrupted image is a still frame extracted from a video.

7. The computer-implemented method of claim 1, wherein generating the reconstructed image is based on deconvolution.

8. The computer-implemented method of claim 1, wherein generating the reconstructed image further comprises processing the corrupted image with the set of spatial frequencies until convergence is reached.

9. A system for reconstructing an image, the system comprising:
a processor;
a first module controlling the processor to receive a corrupted image to reconstruct;
a second module controlling the processor to isolate a set of spatial frequencies in the corrupted image using a wavelet transform; and
a third module controlling the processor to generate a reconstructed image of the corrupted image based on the set of spatial frequencies.

10. The system of claim 9, wherein the third module further isolates the set of spatial frequencies in parallel.

11. The system of claim 9, wherein the third module further isolates the set of spatial frequencies in a specific order.

12. The system of claim 9, wherein the set of spatial frequencies correspond to different zoom levels.

13. The system of claim 9, wherein the corrupted image is blurred.

14. The system of claim 9, wherein the corrupted image is a still frame extracted from a video.

15. The system of claim 9, wherein generating the reconstructed image is further based on deconvolution.

16. The system of claim 9, wherein the third module further controls the processor to process the corrupted image with the set of spatial frequencies until convergence is reached.

17. A non-transitory computer-readable storage medium storing instructions which, when executed by a computing device, cause the computing device to reconstruct an image, the instructions comprising:
receiving a corrupted image to reconstruct;
isolating a set of spatial frequencies in the corrupted image using a wavelet transform; and
generating a reconstructed image of the corrupted image based on the set of spatial frequencies.

18. The non-transitory computer-readable storage medium of claim 17, wherein generating the reconstructed image further comprises reconstructing the set of spatial frequencies in parallel.

19. The non-transitory computer-readable storage medium of claim 17, wherein the set of spatial frequencies correspond to different zoom levels.

20. The non-transitory computer-readable storage medium of claim 17, wherein generating the reconstructed image further comprises processing the corrupted image with the set of spatial frequencies until convergence is reached.
